(19) United States
(12) Patent Application Publication
(10) Pub. No.: US 2005/0140056 A1
(43) Pub. Date: Jun. 30, 2005

(54) Plastics moulding

(75) Inventors: Lee S. Pearson, Rayleigh (GB); Michael Edson, Grays (GB); John Eves, Upminster (GB)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/060,117

(22) Filed: Feb. 17, 2005

Related U.S. Application Data
(62) Division of application No. 09/932,815, filed on Aug. 17, 2001.

(30) Foreign Application Priority Data
Aug. 26, 2000 (GB) GB0021009.6

(51) Int. Cl. B29C 45/14

(52) U.S. Cl. 264/259; 264/45.1

(57) ABSTRACT

A plastics moulded part with a soft-feel surface 12 has a layer of soft material 26,28,30 moulded on the surface of the part. The edges of the soft material are protected and hidden by a rib 44 which is part of the moulded part, which extends in a plane which runs generally parallel to the contour of the part in the region of the rib 44 and which is substantially coplanar with the surface of the part not covered by soft material. The soft material is placed in the mould prior to plastics injection. During injection, the soft material is compressed against the outer mould wall. On ejection from the mould, the soft material recovers and expands so that its outer surface 31 is flush with the outer surface of the rib 44.

This invention relates to a method of and apparatus for moulding a plastics article, at least a part of which has a ‘soft-feel’ finish.

It is known to be desirable to incorporate a ‘soft-feel’, in other words a yieldable surface to parts which have surfaces in the passenger compartment of a motor vehicle. This gives improved aesthetic/tactile comfort for the vehicle occupants and can help to minimise injury in the event of an impact of the vehicle with another object.

Most such parts, for example the instrument panel, the console and the door trims are moulded in a shape which has three dimensions. The manufacture of such parts calls for a moulding technique, which is more often than not a plastics moulding technique. The part needs to have sufficient ‘solid’ plastics to support the shape and to support any loads which will, in use, be imposed on the part.

The ‘soft-feel’ is usually produced by applying a layer of soft material, typically a foamed material, to the part surface. This layer of material can be attached to a moulded part by adhesive after the part itself has been moulded. This is time consuming, difficult to do and expensive.

It is also known to place the layer of soft material in the mould tool and then to use an injection moulding process to mould plastic behind the material. However, with this technique it is difficult to make a tidy edge where the soft material meets the relatively rigid part.

According to the present invention, there is provided a method of manufacturing a plastics moulded part with a soft-feel surface, the method comprising the steps of preparing a sheet of soft material of a desired shape and form, preparing a mould tool to mould the part with a rib on the moulded part extending generally parallel to the surface which will be covered by the soft material, placing the soft material in the mould tool with the edges of the material in register with the rib, injecting molten plastics into the mould tool to fill the tool and to compress the soft material, allowing the mould tool and its contents to cool and removing the moulded part from the tool to allow the soft material to expand to fill the space behind the rib.

Soft material means any sheet-like material which can be compressed in thickness and can subsequently recover to its original thickness. Rubbers and elastomers are examples of such materials, but preferably the material is or includes a foamed plastic. More specifically the material may be a laminate made up of an outer skin (which may be a continuous sheet material or a fabric, eg a woven or knitted cloth), a foam middle layer and an inner skin. After moulding, the inner skin will bond to the injected plastics so that a unitary product is produced.

It is an advantage of the present invention that a moulded part can be produced, with an outer surface which, in part has a soft feel and in part is hard, with the soft surface being substantially flush with the hard surface and there being substantially no gap where the soft feel surface meets the hard surface.

The invention also provides a mould tool for manufacturing a part which has one surface portion having a soft feel finish and another surface portion having a hard finish, wherein the tool half which will form the outer surface of the part has, in the region where the soft feel surface is to meet the hard surface, a cavity region extending substantially parallel to and outboard of the adjacent tool wall such that the moulded part has a rib which extends along the region where the soft-feel surface meets the hard surface.

The invention will now be further described, by way of example, with reference to the accompanying drawings, in which:

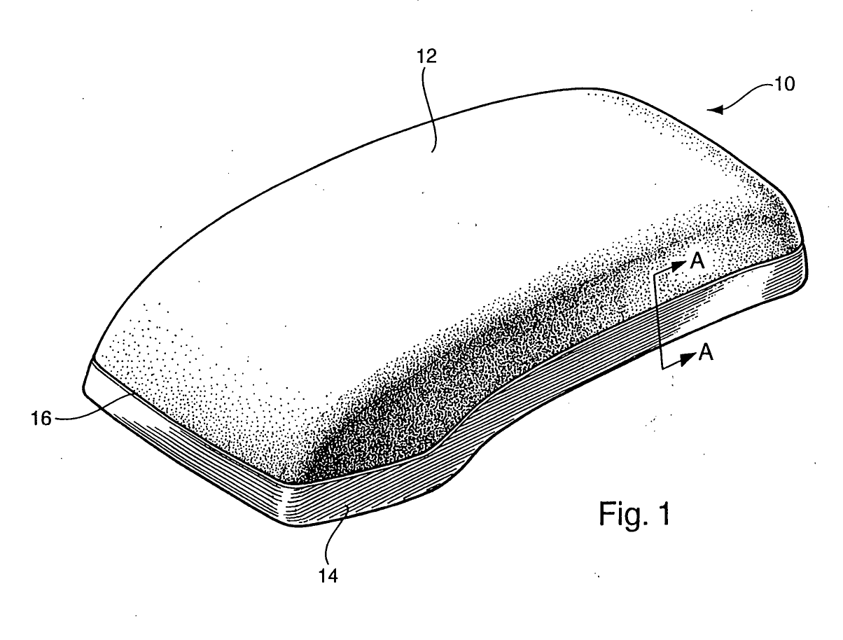

FIG. 1 is a perspective view of a console armrest for a motor vehicle, constructed using the method of the present invention;

FIGS. 2 to 4 show a cross-section through a set of mould tools, at a position corresponding to the position of the line A-A, at three sequential steps in the method; and

FIG. 5 shows a section on the line A-A through part of a completed armrest.

FIG. 1 shows a typical component 10 which can be manufactured using the process of this invention. The component is a motor vehicle armrest which also forms a top cover to a storage box in a vehicle console between the vehicle front seats.

The armrest 10 has an injection moulded plastic body which has a major surface 12 covered in a soft-feel material and an edge region 14 where hard plastic is exposed. This invention is concerned with the region where the soft and hard surfaces meet, ie the detail at the junction line 16.

The armrest is to be manufactured by injection moulding in a moulding tool 18. FIG. 2 shows a section through a part of the tool, the section being taken on the lines A-A from FIG. 1. The tool has a core side 20 and a cavity side 22 which define a cavity 24 between them. The core side 20 and cavity side 24 are shown in the relative positions they take up when the tool is closed.

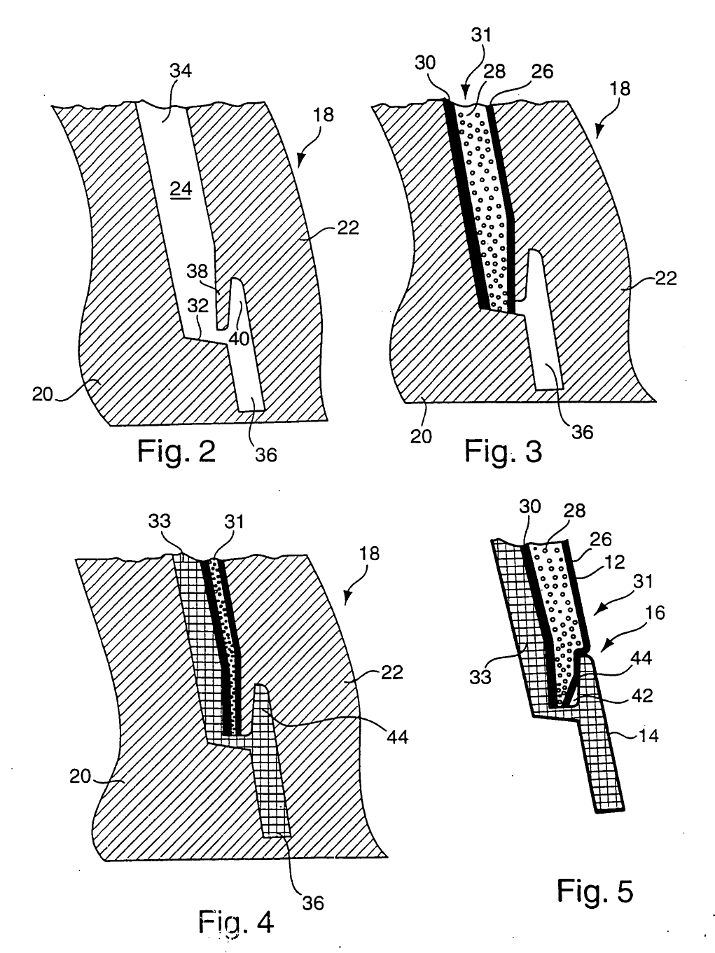

The first stage in manufacturing this armrest is to prepare the material which will form the soft-feel surface. In this example, the material is a three-layer laminate with an outer skin 26, a foam layer 28 and an inner skin 30. This can be seen in FIG. 3. A blank 31 of appropriate size is cut from a sheet, and is then vacuum formed into the approximate three-dimensional shape required to form a the armrest surface.

The tool cavity 24 has an upper region 34 in which the upper part 12 of the armrest will be moulded, and a lower region 36 in which the edge region 14 of the armrest will be moulded. Between these two regions of the tool, there is a transition region. In the transition region, there is a step 32 on the core side of the tool. This step provides an edge against which the soft-feel material can be placed in the mould. On the cavity side of the tool, there is a downwardly-extending fin 38 and, outboard of that fin, a narrow recess 40. All of these features, ie the step, the fin and the recess extend all the way around the tool where the junction line 16 runs.

The next stage in manufacturing is to place the blank 31 in the tool, which at this stage will be open. As can be seen in FIG. 3, the edges of the blank fit against the step 32 in the mould cavity 24. At this stage, the foam is uncompressed and the soft-feel material blank 31 substantially fills the cavity 24.

Next, the tool is closed (FIG. 3) and molten plastic 33 is injected into the tool, using standard injection moulding technology. Details of the injection equipment and of the tool features required to enable injection to take place are not shown, as they will be well known to the skilled man and form no part of this invention. The injection takes place from the core side 20 of the tool, and the pressure generated in the molten plastic by the injection equipment, as well as forcing the molten plastic to flow throughout the tool cavity, also acts against the inner layer 30 of the soft-feel blank 31 to compress the foam 28. This can be seen in FIG. 4. It will also be seen from FIG. 4 that once the foam has been compressed, a passage opens up between the upper and lower regions of the tool cavity at the step 32. The moulding conditions, the composition of the inner laminate layer 30 and the injected plastics will be chosen so that a bond is formed during the injection process between the laminate and the injected plastic.

Suitable materials are: polypropylene for the base moulding, extruded polypropylene for the inner layer 30, polypropylene foam for the core 28 and TPO (thermoplastic olefins) for the outer layer 26. The outer layer can if desired be printed with a grain pattern, carry a flocked surface or have some other decorative finish. Many other different materials and combinations of materials can however be used, and the invention is not restricted to any particular material or materials. Alternatively, the outer skin 26 can be a fabric, for example a woven or knitted fabric.

Once injection has been completed, and the plastic has set, the tool is opened. Once the constraint provided by the cavity tool wall is removed, the foam expands again (this time expanding from the inner laminate layer 30 outwards) so that the soft-feel characteristic is restored and so that the outer layer 26 of the laminate lies flush with the outer surface of the hard plastic edge region 14. The edges of the blank 31 are hidden in a channel 42 formed in the moulded part by the fin 38, and are thus concealed.

The dimensions of the blank and of the tools are deigned so that, when the foam in the blanks expands after removal from the mould tool, the outer surface 12 and 14 are substantially flush with one another. This provides a neat finish to the part, and no major finishing operations are required after the part has been removed from the mould.

1. A method of manufacturing a plastics moulded part with a soft-feel surface, the method comprising the steps of, preparing a sheet of soft material of a desired shape and form, preparing a mould tool to mould the part in such a way that a rib on the molded part extends generally parallel to the surface which will be covered by the foamed material, placing the soft material in the mould tool with the edges of the material in register with the rib, injecting molten plastics into the mould tool to fill the tool and to compress the soft material, allowing the mould tool and its contents to cool and removing the moulded part from the tool to allow the soft material to expand.

2. A method as claimed in claim 1, wherein the soft material includes a foam material.

3. A method as claimed in claim 1, wherein the soft material is a laminate with a layer of foam between two flexible webs.

4. A method as claimed in claim 1, wherein the sheet of soft material is vacuum formed before being placed in the mould tool.

5-7. (canceled)

8. A method of manufacturing a plastic molded part with a soft-feel surface, the method comprising the steps of:
preparing a sheet of soft material of a desired shape and form, the soft material having opposing inner and outer surfaces;
preparing a mold tool including a fin, the mold tool defining a cavity and a recess partially separated from each other by the fin;
placing the soft material in the cavity such that a portion of the outer surface of engages the fin;
injecting molten plastic into the cavity and the recess;
compressing the soft material;
allowing the mold tool and its contents to cool such that the molten plastic located within the cavity hardens to form a body portion extending along the inner surface and such that the molten plastic located within the recess hardens to form a rim;
removing the molded part from the mold too; and
expanding the soft material such that the outer surface of the soft material engages the rim.

9. A method as claimed in claim 8, wherein the soft material includes a foam material.

10. A method as claimed in claim 8, wherein the soft material is a laminate with a layer of foam between two flexible webs.

11. A method as claimed in claim 10, wherein the flexible webs are formed of a thermoplastic olefin material.

12. A method as claimed in claim 8, wherein the sheet of soft material is vacuum formed before being placed in the mold tool.

13. A method as claimed in claim 8, wherein the soft material includes a compressed section and an uncompressed section after the molded part is removed from the mold tool.

14. A method as claimed in claim 13, wherein the body portion and the rim cooperate to compress the compressed section of the soft material.

15. A method as claimed in claim 14, wherein the uncompressed section is flush with an outer surface of the rim after the molded part is removed from the mold tool.

16. A method as claimed in claim 8, wherein the fin is located between the soft material and the rim before the molded part is removed from the mold tool.

17. A method as claimed in claim 8, wherein the cavity and the recess are fluidly connected such that the body portion and the rim are a single, unitary part.

18. A method as claimed in claim 17, the plastic molded part further comprising an intermediate portion extending between the body portion and the rim.

19. A method as claimed in claim 18, wherein the body portion and the rim generally extend along a first direction and the intermediate portion extends along a second direction substantially perpendicular to the first direction.

20. A method as claimed in claim 8, wherein the soft material is compressed by the injected molten plastic.
